(19) United States
(12) Patent Application Publication
(10) Pub. No.: US 2012/0039146 A1
(43) Pub. Date: Feb. 16, 2012

(54) DUAL TUBE GAS DIFFUSION SYSTEM

(76) Inventor: Kyriacos ZANTI, Larnaca (CY)

(21) Appl. No.: 12/856,703

(22) Filed: Aug. 16, 2010

(51) Int. Cl. B01F 3/04; B01F 13/02; C02F 1/74

(52) U.S. Cl. 366/101; 261/76

(57) ABSTRACT

A gas diffusion system comprising a dual pipe diffuser having an inner pipe with perforations through which gas flows and diffuses into a fluid or liquid flowing through an outer pipe that surrounds the inner pipe. The gas diffusion system provides good diffusion of gas into the liquid flow, with no gas loss and requires minimal equipment or space. The gas diffuser allows for easy control of the gas, is low cost and can easily be installed in existing systems.

### FIELD OF THE INVENTION

The present invention relates to a gas diffusion system that can be used in any application where it is necessary to introduce a gas into a fluid or liquid.

### BACKGROUND OF THE INVENTION

Gas diffusion into a fluid or liquid is an important operation for many industrial applications, including waste water treatment and aquaculture. Prior art gas diffusers can consist of a pipe that supplies gas through holes or perforations in the walls of the pipe to a surrounding liquid. For example, a gas supply pipe can be positioned on the bottom of a pond so that gases, such as oxygen or carbon dioxide can be added to the water in the pond for water treatment or aquaculture purposes. However, such pipes are subject to clogging and other mechanical problems and may be easily damaged. Other prior art gas diffusers can be relatively complicated, take up a considerable amount of space and have a high cost.

Therefore, there is a need in the art for improvements to gas diffusion systems.

### SUMMARY OF THE INVENTION

The present invention provides a gas diffusion system that provides gas injection close to the point of use, with good diffusion into the liquid flow, and no gas loss. Further, the gas diffusion system of the present invention requires minimal equipment (or additional equipment if a diffuser is already in place), and a minimal amount of extra space. The gas diffuser of the present invention allows for easy control of the gas, is low cost and can easily be installed in existing systems.

### BRIEF DESCRIPTION OF THE DRAWINGS

FIG. 1 is a schematic view of a gas diffusion system according to one embodiment of the present invention.

### DETAILED DESCRIPTION OF THE INVENTION

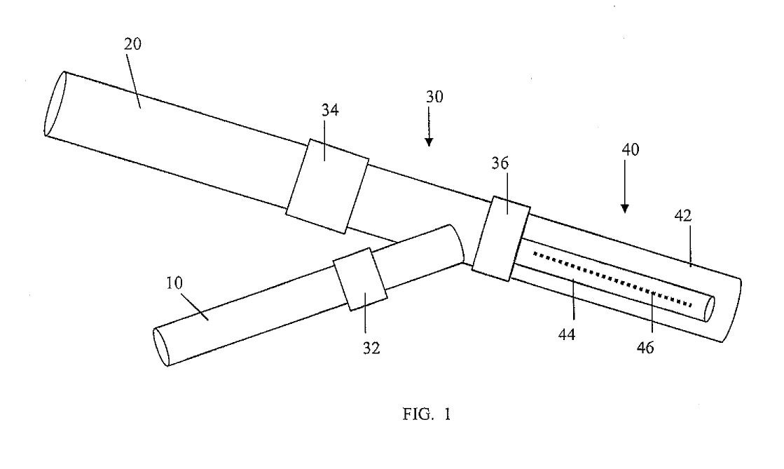

The present invention relates to a gas diffusion system that can be used in any application where it is necessary to introduce a gas into a fluid or liquid. The present invention will be described in greater detail with reference to FIG. 1.

In particular, FIG. 1 is a schematic view of a gas diffuser according to one embodiment of the present invention comprising a gas inlet pipe 10, a fluid or liquid inlet pipe 20, a Y-connector 30, and a dual pipe outlet 40. The gas inlet pipe 10, connects with the Y-connector 30, through an adapter 32, that provides for leak-proof connection. Similarly, the fluid inlet pipe 20, connects with the Y-connector 30, through an adapter 34, that provides for leak-proof connection. The dual pipe outlet 40, is connected to the outlet side 36, of the Y-connector 30, and comprises an outer pipe 42, through which the fluid or liquid flows, and an inner pipe 44, through which the gas flows. The inner pipe 44, includes holes or perforations 46 that allow the gas to exit the inner pipe 44, and diffuse into the liquid in outer pipe 42. The liquid into which the gas has been diffused can then exit the system into the surrounding fluid or liquid in which the gas diffuser system in situated.

To assure leak proof connections, the adapters 32 and 34 can provide clamping action between the inlet pipes and the Y-connector and may include o-rings or other sealing means. The gas inlet pipe 10, and the fluid inlet pipe 20, and the outer pipe 42 of the dual pipe outlet 40 may be made of any suitable material for the desired application, including steel, aluminum, copper, plastic, PVC, etc. The inner pipe 44, of the dual pipe outlet 40, may also be made of any of the materials noted above, but is preferably made of a flexible material. The perforations 46, can be of any desired size or shape to provide for optimal diffusion in the desired operation. While the invention has been described with a Y-connector, any other connector, such as a T-connector or another configuration is also within the scope of the present invention.

The present invention provides a gas diffusion system having many advantages over those known in the prior art. In particular, the gas diffusion system of the present invention offers flexible construction parameters that may be adapted to the desired operation at low cost. The gas diffusion system of the present invention provides efficient gas diffusion into the liquid or fluid with easy gas control and delivery to the point of use if desired. In addition, the gas diffusion system of the present invention requires minimal space and minimal equipment (or additional equipment if a diffuser is already in place), and may be easily installed in existing systems.

It will be understood that the embodiments described herein are merely exemplary and that one skilled in the art may make variations and modifications without departing from the spirit and scope of the present invention. All such variations and modifications are intended to be included within the scope of the invention as described above. Further, all embodiments disclosed are not necessarily in the alternative, as various embodiments of the invention may be combined to provide the desired result.

What is claimed is:

1. A gas diffusion system comprising:
a gas inlet;
a fluid inlet;
a connector receiving the gas inlet and the fluid inlet; and
an outlet from the connector having an outer conveyance means for passage of fluid from the fluid inlet and surrounding an inner conveyance means for passage of the gas from the gas inlet which allows the gas to diffuse into the fluid contained in the outer conveyance means through perforations formed through the inner conveyance means.

2. The gas diffusion system of claim 1 wherein the gas inlet, fluid inlet and outlet are pipes.

3. The gas diffusion system of claim 1 wherein the connector is a Y-connector.

4. The gas diffusion system of claim 1 wherein the connector is a T-connector.

5. The gas diffusion system of claim 1 wherein the gas inlet, the fluid inlet, the connector and the outlet are made of any suitable material including steel, aluminum, copper, plastic, or PVC.

6. The gas diffusion system of claim 1 for use in a wastewater treatment process.

7. A method of diffusing a gas into a fluid comprising:
providing a gas source and a fluid source;
connecting the gas source to a gas inlet of a connector and the fluid source to a fluid inlet of the connector;
connecting an outlet to the connector, the outlet having an outer conveyance means for passage of fluid from the fluid inlet and surrounding an inner conveyance means for passage of the gas from the gas inlet, wherein the inner conveyance means has perforations formed therethrough;
sending gas from the gas source through the gas inlet and into the inner conveyance means of the outlet;
sending fluid from the fluid source through the fluid inlet and into the outer conveyance means of the outlet; and
diffusing the gas into the fluid through the perforations of the inner conveyance means.
